(19) United States
(12) Patent Application Publication
(10) Pub. No.: US 2026/0204203 A1
(43) Pub. Date: Jul. 16, 2026

(54) DISPLAY DEVICE AND DISPLAY METHOD

(71) Applicant: Coretronic Corporation, Hsin-Chu (TW)

(72) Inventors: Wen-Cheng Hung, Hsin-Chu (TW); Keng-Chia Chang, Hsin-Chu (TW); Kai-Hao Chang, Hsin-Chu (TW); Te-Sung Su, Hsin-Chu (TW)

(73) Assignee: Coretronic Corporation, Hsin-Chu (TW)

(21) Appl. No.: 19/442,985

(22) Filed: Jan. 7, 2026

(30) Foreign Application Priority Data
Jan. 14, 2025 (CN) 202510055271.5

(51) Int. Cl. G09G 3/20; G09G 3/00; H04N 9/31

(52) U.S. Cl. CPC G09G 3/2096; G09G 3/002; G09G 2340/0428; G09G 2340/06; G09G 2360/12; G09G 2360/16; H04N 9/3182; H04N 9/3188

(57) ABSTRACT

Provided is a display device, which includes a receiving circuit, a brightness information generating circuit, a conversion curve generating circuit, a frame conversion circuit, and an image display module. The receiving circuit is configured to receive an input image signal. The brightness information generating circuit obtains original brightness information and set brightness information of each of original frames through analyzing each of the original frames in the input image signal. The conversion curve generating circuit generates an electro-optical transfer lookup table of each of the original frames according to the set brightness information of each of the original frames and a conversion function. The frame conversion circuit performs electro-optical transfer lookup on the original frames of the input image signal according to the electro-optical transfer lookup table corresponding to each of the original frames to generate multiple output frames of an output image signal.

### CROSS-REFERENCE TO RELATED APPLICATION

This application claims the priority benefit of China application serial no. 202510055271.5, filed on Jan. 14, 2025. The entirety of the above-mentioned patent application is hereby incorporated by reference herein and made a part of this specification.

### BACKGROUND

### Technical Field

The disclosure relates to a display device and a display method, and in particular relates to a display device and a display method, which can generate an electro-optical transfer lookup table frame by frame.

### Related Art

High dynamic range (HDR) image processing technology is an imaging technology widely applied to displays, aiming to enhance the contrast and color performance of images.

Image signals compatible with the HDR format include metadata, which are configured to record multiple original parameters of an image signal, such as brightness information, color space information, etc. When outputting images, a display with HDR functionalities calculates a mapping relationship curve between an input signal value and a brightness output on the display device, that is, an electro-optical transfer function (EOTF) curve, according to the EOTF and information in the metadata as parameters. The EOTF curve is stored in a form of an EOTF lookup table, which is configured to ensure precise reproduction of image brightness and contrast on the display. Current HDR technology may further be divided into static HDR and dynamic HDR. Static HDR image signals have fixed metadata, so the same mapping relationship curve is used by different frames, and an output image cannot be optimized frame by frame or according to the scene. Dynamic HDR image signals include multiple metadata corresponding to each frame or different scenes. The mapping relationship curve is calculated frame by frame through the software of the user interface of the display, providing optimized image presentation effects according to different frames or scenes. However, this manner imposes a higher computational burden on the processor of the display, and a longer adjustment time is needed for calculating a new mapping relationship curve, which may not satisfy the instant need for frame-by-frame updates.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In view of the limitations or deficiencies in both dynamic HDR display technology or static HDR display technology in the prior art, the disclosure proposes a display device, which includes a receiving circuit, a brightness information generating circuit, a conversion curve generating circuit, a frame conversion circuit, and an image display module. The receiving circuit is configured to receive an input image signal. The input image signal includes multiple original frames, and each of the multiple original frames include multiple original pixels. The brightness information generating circuit electrically connected to the receiving circuit is configured to receive the input image signal from the receiving circuit. The brightness information generating circuit obtains original brightness information of each of the multiple original frames according to the input image signal, and generates set brightness information corresponding to each of the multiple original frames according to the original brightness information. The conversion curve generating circuit electrically connected to the brightness information generating circuit is configured to generate an electro-optical transfer lookup table according to the set brightness information of each of the multiple original frames and a conversion function. The frame conversion circuit electrically connected to the receiving circuit and the conversion curve generating circuit is configured to receive the electro-optical transfer lookup table corresponding to each of the multiple original frames from the conversion curve generating circuit, and receive the input image signal from the receiving circuit and generate an output image signal. The frame conversion circuit performs electro-optical transfer lookup on each of the multiple original frames of the input image signal according to the electro-optical transfer lookup table corresponding to each of the multiple original frames to generate multiple output frames of the output image signal. Each of the multiple output frames includes multiple output pixels. The image display module is electrically connected to the frame conversion circuit to receive the output image signal, and displays an output image according to the output image signal.

The disclosure further proposes a display method, executed by a display device. The display device includes a receiving circuit, a brightness information generating circuit, a conversion curve generating circuit, a frame conversion circuit, and an image display module. The display method includes the following steps: an input image signal is received by the receiving circuit, the input image signal includes multiple original frames, and each of the multiple original frames include multiple original pixels; the input image signal is received from the receiving circuit by the brightness information generating circuit, original brightness information of each of the multiple original frames is obtained according to the input image signal, and set brightness information corresponding to each of the multiple original frames is generated according to the original brightness information; an electro-optical transfer lookup table is generated by the conversion curve generating circuit according to the set brightness information of each of the multiple original frames and a conversion function; the electro-optical transfer lookup table corresponding to each of the multiple original frames is received from the conversion curve generating circuit by the frame conversion circuit, the input image signal is received from the receiving circuit, and an output image signal is generated; and an output image is displayed by the image display module according to the output image signal; a step of generating the output image signal is performing electro-optical transfer lookup on each of the multiple original frames of the input image signal by the frame conversion circuit according to the electro-optical transfer lookup table corresponding to each of the multiple original frames to respectively generate multiple output frames of the output image signal. Each of the multiple output frames includes multiple output pixels.

Compared to the known technology where the electro-optical transfer lookup table is generated by the software of the user interface of the display device according to information in the metadata, the method of the disclosure generates the electro-optical transfer lookup table more efficiently, can actually generate the electro-optical transfer lookup table frame by frame, and can effectively perform adaptive adjustment on each of the output frames. The disclosure solves the problem in the known technology where static HDR may not adjust the electro-optical transfer curve according to the frame or scene, and also solves the problem where dynamic HDR may only generate different electro-optical transfer lookup tables according to different metadata, and may not optimize frame by frame due to software computational limitations.

In order to make the features and advantages of the disclosure more comprehensible, the following examples are given and described in detail with the accompanying drawings as follows.

### BRIEF DESCRIPTION OF THE DRAWINGS

FIG. 1 is a block diagram of a display device according to a first embodiment of the disclosure.

FIG. 2 is a block diagram of a display device according to a second embodiment of the disclosure.

FIG. 3 is a flow chart of calculating a set brightness information by the display device in the second embodiment of the disclosure.

FIG. 4 is a block diagram of a display device according to a third embodiment of the disclosure.

FIG. 5 is a block diagram of a display device according to a fourth embodiment of the disclosure.

FIG. 6 is a block diagram of a display device according to a fifth embodiment of the disclosure.

FIG. 7 is a block diagram of a display device according to another embodiment of the disclosure.

FIG. 8 is a flow chart of a display method according to the disclosure.

FIG. 9 is a block diagram of a projection device according to the disclosure.

### DETAILED DESCRIPTION OF EMBODIMENTS

Some embodiments of the disclosure will be described in detail below with reference to the accompanying drawings. Reference numerals used in the following description will be regarded as identical or similar elements when the same reference numerals appear in different drawings. These embodiments are only part of the disclosure, and do not disclose all possible embodiments of the disclosure. Rather, these embodiments are merely examples of the systems and methods within the scope of the disclosure.

The foregoing and other technical contents, features and effects of the disclosure will be clearly presented in the following detailed description of a preferred embodiment with reference to the accompanying drawings. The directional terms mentioned in the following embodiments, such as up, down, left, right, front or back, etc., are only with reference to the directions in the drawings. Therefore, the directional terms used are intended to illustrate and not to limit the disclosure.

The disclosure proposes a display device and a display method, which can dynamically generate an electro-optical transfer lookup table for each frame.

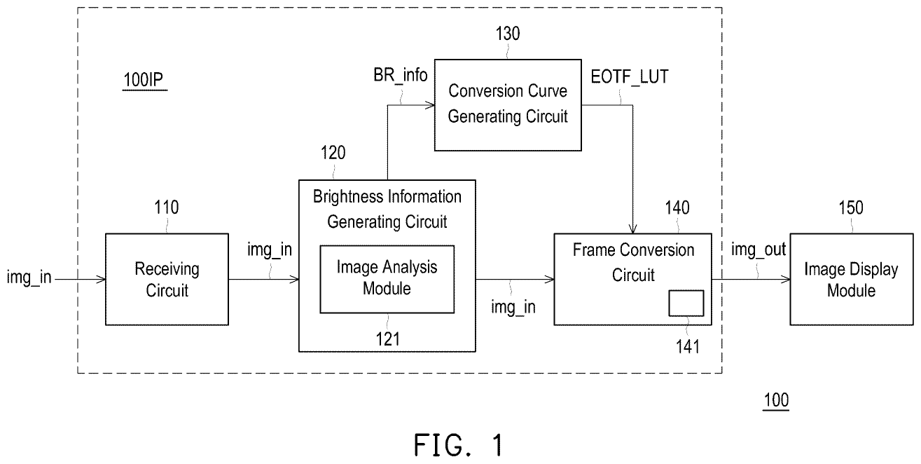

FIG. 1 is a system block diagram of a display device according to a first embodiment. Please refer to FIG. 1. A display device 100 includes a receiving circuit 110, a brightness information generating circuit 120, a conversion curve generating circuit 130, a frame conversion circuit 140, and an image display module 150. The receiving circuit 110 is electrically connected to the brightness information generating circuit 120. The brightness information generating circuit 120 is electrically connected to the conversion curve generating circuit 130 and the frame conversion circuit 140. The frame conversion circuit 140 is further electrically connected to the conversion curve generating circuit 130. The image display module 150 is electrically connected to the frame conversion circuit 140. The display device 100 includes, for example, at least one image processor 100IP. In the embodiment, the at least one image processor 100IP is an Altera® FPGA. The at least one image processor 100IP includes the foregoing receiving circuit 110, the brightness information generating circuit 120, the conversion curve generating circuit 130, and the frame conversion circuit 140. In other embodiments, the at least one image processor 100IP may, for example, be a central processing unit (CPU), or other programmable general-purpose or specific-purpose micro control unit (MCU), microprocessor, digital signal processor (DSP), programmable controller, application specific integrated circuit (ASIC), arithmetic logic unit (ALU), complex programmable logic device (CPLD), field programmable gate array (FPGA), or other similar elements or a combination of the foregoing elements.

The receiving circuit 110 may be compatible with any suitable transmission specification, including high definition multimedia interface (HDMI), display port (DP), universal serial bus type C (USB-C), thunderbolt, wireless transmission module, etc., and the disclosure is not limited thereto. The receiving circuit 110 is electrically connected to a port of the display device 100, and configured to receive an input image signal img_in from an external signal source. The input image signal img_in includes multiple original frames. Each of the original frames includes multiple original pixels. Each of the original pixels includes multiple color channels. The color channels include, for example, at least one of a red channel, a green channel and a blue channel. Each of the color channels is, for example, represented by a grayscale value.

The brightness information generating circuit 120 receives the input image signal img_in from the receiving circuit 110, obtains an original brightness information of each of the original frames according to the input image signal img_in, and generates a set brightness information BR_info corresponding to each of the original frames according to the original brightness information of each of the original frames. The original brightness information may be obtained by analyzing all the original pixels of each of the original frames. In some embodiments, the brightness information generating circuit 120 includes an image analysis module 121. The image analysis module 121 receives the input image signal img_in and calculates a maximum value among the grayscale values of all the color channels of all the original pixels in each of the original frames in the input image signal img_in to serve as the original brightness information. For example, in a first original frame in the input image signal img_in, if the maximum value of all the original pixels in the red channel is “250”, the maximum value of all the original pixels in the green channel is “220”, and the maximum value of all the original pixels in the blue channel is “225”, the maximum value among these color channels is “250”. This value may serve as the original brightness information of the first frame. Here, corresponding original brightness information may be calculated for each of the original frames.

In other embodiments, the color channels of the original frames may also be converted to other color spaces, such as YUV, YCrCb, HSI, etc., and then a maximum brightness (such as Y in the YUV color space) is obtained therein to serve as the original brightness information. In some embodiments, some preprocessing (such as removing bright spots) may also be performed on these color channels, and then the maximum value among all the color channels may be obtained to serve as the original brightness information.

After the original brightness information has been calculated, the brightness information generating circuit 120 may generate the set brightness information BR info corresponding to each of the original frames according to the original brightness information. In some embodiments, the brightness information generating circuit 120 takes the original brightness information of each of the original frames to serve as the set brightness information BR_info. In other words, the set brightness information BR_info of each of the original frames is the same as the original brightness information. In other embodiments, the original brightness information of the multiple original frames which are continuous in sequence may be obtained, and then a low pass filter processing may be executed on the original brightness information to generate the set brightness information BR_info of each of the original frames, thereby avoiding frame flickering caused by excessively high frequency of changes in the set brightness information. In some other embodiments, changes between the original brightness information of two continuous original frames may also be limited within a preset range to generate the set brightness information BR_info, thereby avoiding viewing discomfort caused by excessive changes in the set brightness information.

The conversion curve generating circuit 130 receives the set brightness information BR info from the brightness information generating circuit 120, and generates an electro-optical transfer lookup table EOTF_LUT corresponding to each of the original frames according to the set brightness information BR_info of each of the original frames and a conversion function. An input value of the conversion function is a grayscale value, such as a grayscale value of a color channel of an input pixel in an input image signal. An output value of the conversion function is a brightness value of a color channel of a corresponding output pixel in an output image. The conversion function may refer to standards established by the Society of Motion Picture and Television Engineers (SMPTE) or other organizations. For example, the conversion function is shown in the following mathematical equation 1.

$${F}_{D} = EOTF [ {E}^{′} ] = 10000 Y \qquad [ Mathematical Equation 1 ]$$

$$Y = {( \frac{max [ ( {E}^{\text{?}} - {c}_{1} ) , 0 ]}{{c}_{2} - {c}_{3} {E}^{\text{?}}} )}^{\text{?}}$$

$$\text{?} \text{indicates text missing or illegible when filed}$$

where E′ is the normalized linear grayscale value, such as a grayscale value in the red channel, the green channel or the blue channel, or may also be a color value in an LMS color space. F_{D} is the linear brightness value. Y is the normalized nit value with a range of [0:1]. m₁, m₂, c₁, c₂, c₃ are preset parameters. For example, m₁=2610/16384=0.1593017578125; m₂=2523/4096*128−78.84375; c₁=3424/4096−0.8359375=c₃−c₃+1; c₂=2413/4096*32=18.8515625; c₃=2392/4096*32=18.6875, but the disclosure does not limit the values of the preset parameters.

Specifically, a method by which the conversion curve generating circuit 130 generates the electro-optical transfer lookup table EOTF_LUT corresponding to the original frames according to the set brightness information BR_info of each of the original frames in the input image signal and the conversion function is described as follows. First, a range is set according to the set brightness information BR_info of the original frame to serve as an upper limit value B. The range is represented as [0,B]. Next, each positive integer value from 0 to B within [0,B] is substituted into the grayscale value E′ of the conversion function in sequence to generate the corresponding brightness value F_{D}, and the brightness value F_{D} that has been output is stored in the field corresponding to the grayscale value in the electro-optical transfer lookup table EOTF_LUT, thereby generating the electro-optical transfer lookup table EOTF_LUT.

The frame conversion circuit 140 receives the electro-optical transfer lookup table EOTF_LUT of each of the original frames from the conversion curve generating circuit 130. The frame conversion circuit 140 includes, for example, a storage unit 141, configured to store the electro-optical transfer lookup table EOTF_LUT. Specifically, the frame conversion circuit 140 may update the electro-optical transfer lookup table EOTF_LUT in the storage unit 141 each time the electro-optical transfer lookup table EOTF_LUT of the original frame is received by a manner of updating, thereby storing the electro-optical transfer lookup table EOTF_LUT of each of the original frames. In addition, the frame conversion circuit 140 may also store the electro-optical transfer lookup tables EOTF_LUT within a period of time or for all the original frames in the storage unit 141, and then read the electro-optical transfer lookup table EOTF_LUT corresponding to each of the original frames when performing an optical conversion lookup. On the other hand, the frame conversion circuit 140 receives the input image signal img_in and generates an output image signal img_out. The frame conversion circuit 140 performs electro-optical transfer lookup on each of the multiple original frames of the input image signal img_in according to the corresponding electro-optical transfer lookup table EOTF_LUT to respectively generate multiple output images of the output image signal img_out. Each of the output images includes multiple output pixels. Specifically, the frame conversion circuit 140 performs the electro-optical transfer lookup for each of the original pixels in the original frame to generate each of the output pixels of each of the output frames of the output image signal img_out. In more detail, the frame conversion circuit 140 looks up the corresponding brightness value in the electro-optical transfer lookup table EOTF_LUT according to the grayscale value of each color channel of the original pixels to serve as the brightness value of each color channel of the output pixels corresponding to the original pixels in the corresponding output frame.

The image display module 150 receives the output image signal from the frame conversion circuit 140 and displays the output images according to the output image signal. The image display module 150 may be any display technology configured to present images to users. For example, if the display device 100 is a liquid crystal display device, the image display module 150 is a liquid crystal display panel and a controller (or a processor) configured to control the liquid crystal display panel. If the display device 100 is a projection device, the image display module 150 includes, for example, a light valve and a controller (or a processor) configured to control the light valve.

In the disclosure, the brightness information generating circuit 120 and the conversion curve generating circuit 130 are independent circuit modules. The brightness information generating circuit 120 generates the set brightness information of each of the original frames. The conversion curve generating circuit 130 generates the electro-optical transfer lookup table of each of the original frames. In other words, in the disclosure, the electro-optical transfer lookup table is generated without the software of the user interface of the display device 100. Compared to the known technology, the method of the disclosure generates the electro-optical transfer lookup table more efficiently, can actually generate the electro-optical transfer lookup table frame by frame, and can effectively perform adaptive adjustment on each of the output frames. The disclosure solves the problem in the known technology where dynamic HDR may only generate different electro-optical transfer lookup tables according to different metadata, and may not optimize frame by frame due to software computational limitations.

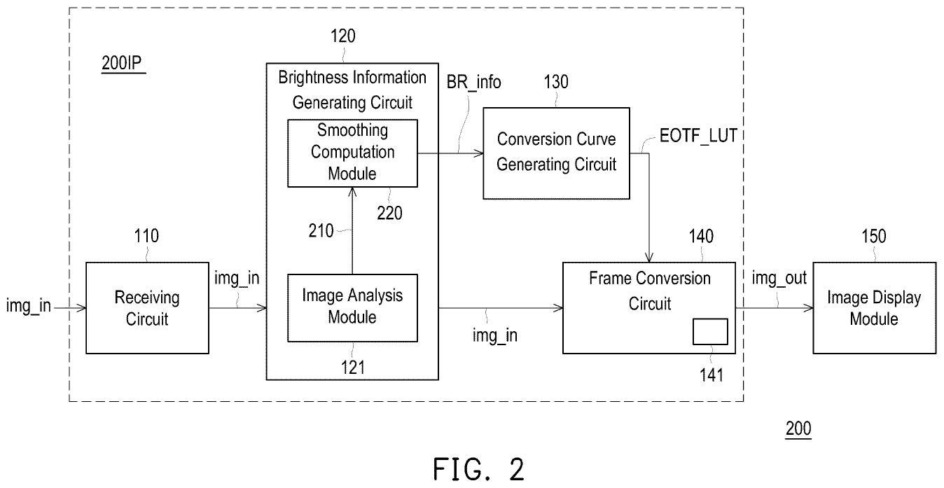

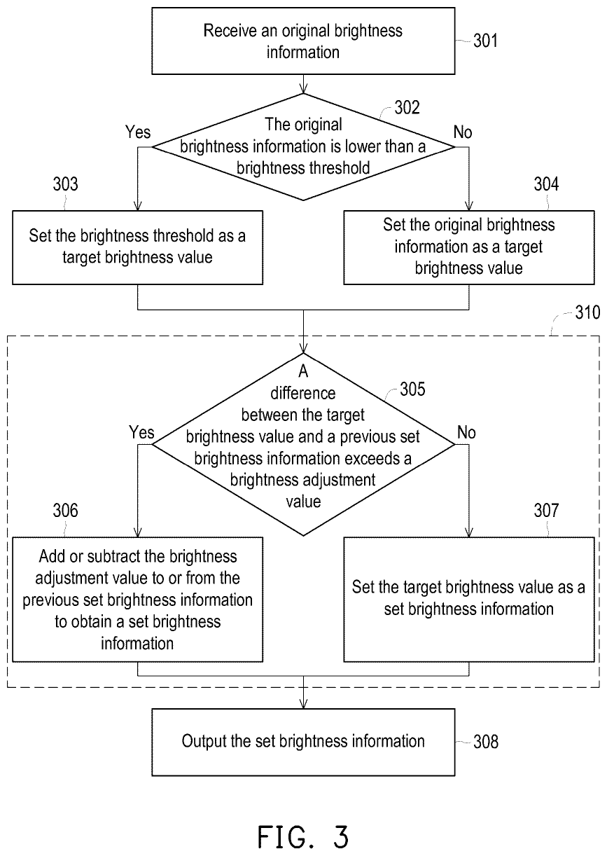

FIG. 2 is a system block diagram of a display device according to a second embodiment of the disclosure. Please refer to FIG. 2. The display device 200 may include at least one image processor 200IP. The at least one image processor 200IP includes the foregoing receiving circuit 110, the foregoing brightness information generating circuit 120, the conversion curve generating circuit 130, and the frame conversion circuit 140. For specific implementations of the image processor 200IP, please refer to the description of the image processor 100P, which will not be reproduced here. The difference between the second embodiment and the first embodiment is that the brightness information generating circuit 120 of the image processor 200IP of the display device 200 further includes a smoothing computation module 220, which is electrically connected to the image analysis module 121. The image analysis module 121 calculates the original brightness information 210 corresponding to each of the original frames. The smoothing computation module 220 receives the original brightness information 210 and generates the set brightness information BR_info according to the original brightness information 210. FIG. 3 is a flow chart of generating the set brightness information BR_info by the smoothing computation module 220, including steps 301 to 308. In step 301, an original brightness information is received. In step 302, whether the original brightness information is lower than a brightness threshold is determined. If the result of step 302 is yes, in step 303, the brightness threshold is set as a target brightness value. If the result of step 302 is no, in step 304, the original brightness information is set as the target brightness value. That is to say, the calculation of the target brightness value may be represented by the following mathematical formula 2.

$$T B = max ( {T}_{1} , OB ) \qquad [ Mathematical Formula 2 ]$$

where OB is the original brightness information, T₁ is the brightness threshold, and TB is the target brightness value. That is to say, the brightness threshold serves as a lower limit of the target brightness value. The reason for setting the brightness threshold will be described as follows.

After the target brightness value is determined, the difference between the target brightness value and the set brightness information (previous set brightness information) of the last original frame (the previous original frame) may be calculated in step 310. The set brightness information (current set brightness information) of the original frame currently being determined (current original frame) is generated according to the difference. For example, a brightness adjustment value is set. When the difference between the target brightness value of the original frame being determined and the previous set brightness information is too large (such as greater than the brightness adjustment value), the target brightness value is increased or decreased in units of the brightness adjustment value to generate the set brightness information. In this way, when the difference between the set brightness information and the previous set brightness information is too large, frame flickering of the output images may be avoided.

Specifically, step 310 includes steps 305 to 307. In step 305, whether the difference between the target brightness value and the previous set brightness information exceeds the brightness adjustment value is determined. If the result of step 305 is yes, in step 306, the brightness adjustment value is added to or subtracted from the previous set brightness information to obtain the set brightness information. Specifically, if the target brightness value is greater than the previous set brightness information, the brightness adjustment value is added to the previous set brightness information to obtain the set brightness information of the original frame currently being determined. If the target brightness value is less than the previous set brightness information, the brightness adjustment value is subtracted from the previous set brightness information to obtain the set brightness information of the original frame currently being determined. If the result of step 305 is no, this represents that the difference between the target brightness value and the previous set brightness information is less than or equal to the brightness adjustment value. Next, in step 307, the target brightness value is set as the set brightness information. Finally, in step 308, the set brightness information is output.

Here, the purpose of the brightness threshold is described. According to the foregoing steps 301 to 310, the brightness threshold is the lower limit of the target brightness value or the set brightness information. When the original brightness information is lower, which represents that the overall brightness of the original frame is too low, the brightness threshold is taken to serve as the lower limit of the set brightness value, avoiding the overall frame brightness of the output frames being too low. On the other hand, since each adjustment in step 306 is performed in units of the brightness adjustment value, when switching between different scenes (including continuous multiple frames and the multiple frames having similar brightness information), if the difference between the set brightness information of a previous scene and the set brightness information of a next scene is too large, the previous scene may need to go through more frames to achieve the set brightness value of the next scene. The adjustment speed of switching brightness between scenes may be too slow, leading to poor viewing experience. Accordingly, taking the brightness threshold to serve as the lower limit of the set brightness value may limit the range of difference in the set brightness values between two scenes.

Please refer to FIG. 2 again. In the second embodiment, the operating principles of the conversion curve generating circuit 130 and the frame conversion circuit 140 are the same as those in the first embodiment, so they will not be reproduced here.

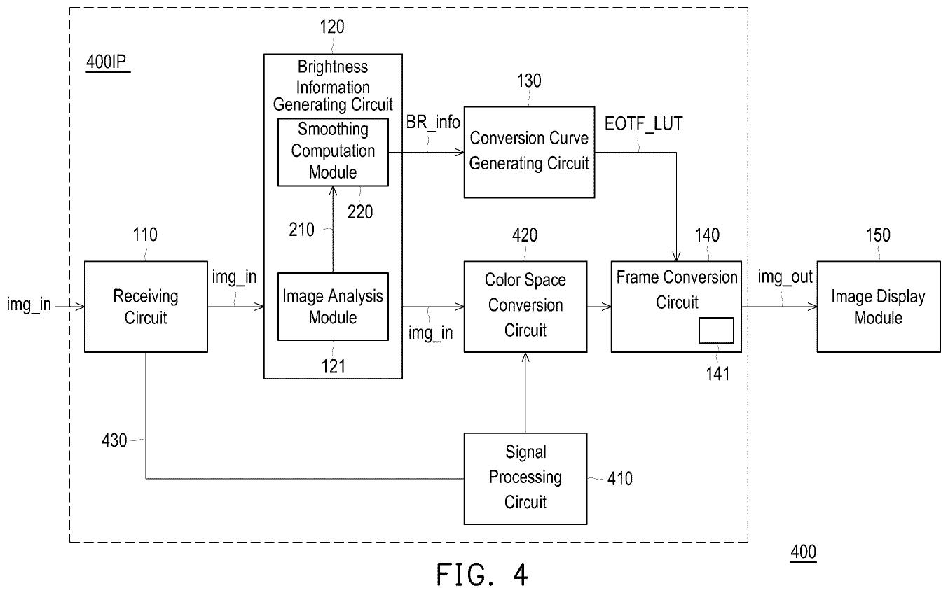

FIG. 4 is a system block diagram of a display device according to a third embodiment of the disclosure. A display device 400 includes, for example, at least one image processor 400IP. For specific implementations of the image processor 400IP, please refer to the description of the image processor 100P, which will not be reproduced here. The difference between the third embodiment and the first embodiment or the second embodiment is that the display device 400 further includes a signal processing circuit 410 and a color space conversion circuit 420. The at least one image processor 400IP includes the receiving circuit 110, the brightness information generating circuit 120, the conversion curve generating circuit 130, the frame conversion circuit 140, the signal processing circuit 410, and the color space conversion circuit 420. The signal processing circuit 410 is electrically connected to the receiving circuit 110 and the color space conversion circuit 420. The color space conversion circuit 420 is electrically connected between the brightness information generating circuit 120 and the frame conversion circuit 140. In the embodiment, the receiving circuit 110 obtains metadata from the input image signal img_in. The signal processing circuit 410 receives a metadata 430 from the receiving circuit 110 and determines whether the input image signal img_in is compatible with a high dynamic range (HDR) format according to the metadata 430. For example, the metadata 430 may include information in one or more fields configured to represent whether the high dynamic range format is supported. The high dynamic range format is, for example, HDR10, HDR10+, or dolby vision. Alternatively, if the input image signal img_in is compatible with the high dynamic range format, the metadata 430 may include information such as original color space information of a video, a maximum brightness value in the video, and a definition of white. The original color space information includes, for example, coordinates of the red channel, the green channel, and the blue channel in the CIE-1931 chromaticity diagram.

On the other hand, the color space conversion circuit 420 stores display color space information corresponding to the display device 400, including, for example, the coordinates of the red channel, the green channel, and the blue channel in the CIE-1931 chromaticity diagram. When the signal processing circuit 410 determines that the input image signal img_in is compatible with high dynamic range format, the color space conversion circuit 420 may convert the original pixels of each of the original frames from an original color space to a display color space according to the original color space information and the display color space information included in the metadata. For example, the color space conversion circuit 420 may create a matrix with a dimension of 3*3 according to the original color space information and the display color space information, and multiply the matrix by the grayscale values of the three color channels of the original pixels (forming a vector) to obtain the grayscale values of the three color channels in the display color space. It is worth noting that the operation of the color space conversion circuit 420 and the operation of the conversion curve generating circuit 130 are parallel, which may increase the overall computation speed.

The frame conversion circuit 140 may receive the original frames that have been converted, perform electro-optical transfer lookup on the original frames that have been converted to respectively generate multiple output frames, and provide the output image signal img_out with the multiple output images to the image display module 150. Therefore, the display device 400 of the embodiment may further be configured to process image signals compatible with the HDR format. Since the corresponding electro-optical transfer lookup table EOTF_LUT is generated for each of the original frames through the brightness information generating circuit 120 and the conversion curve generating circuit 130, regardless of whether the input image signal belongs to static HDR or dynamic HDR, the output frames may all be optimized according to the brightness information of each of the original frames. On the other hand, the disclosure allows image signals which are originally static HDR to also generate video display effects that are optimized frame-by-frame on the display.

It is worth mentioning that the display device 400 of the third embodiment may also be configured for image signals that are not compatible with the HDR format. When the signal processing circuit 410 determines that the input image signal img_in is not compatible with the high dynamic range format, the color space conversion circuit 420 does not perform color space conversion. The original frames in the input image signal img_in may be directly transmitted to the frame conversion circuit 140 through the color space conversion circuit 420.

In the third embodiment, the operating principles of the brightness information generating circuit 120, the conversion curve generating circuit 130, and the frame conversion circuit 140 are the same as those in the second embodiment, so they will not be reproduced here.

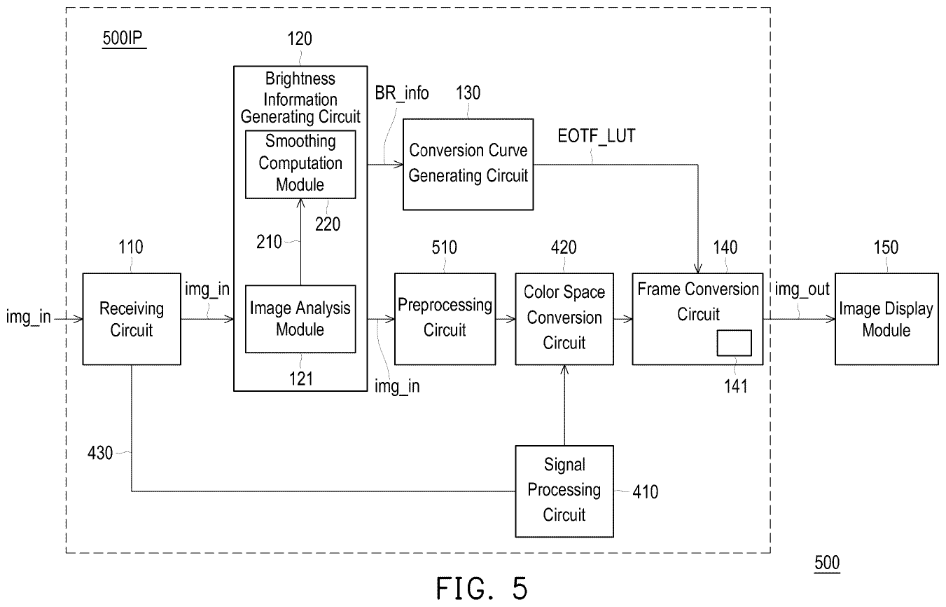

FIG. 5 is a system block diagram of a display device according to a fourth embodiment of the disclosure. A display device 500 includes, for example, at least one image processor 500IP. The at least one image processor 500IP includes the receiving circuit 110, the brightness information generating circuit 120, the conversion curve generating circuit 130, the frame conversion circuit 140, and a preprocessing circuit 510. For specific implementations of the image processor 500IP, please refer to the description of the image processor 100P, which will not be reproduced here. The difference between the fourth embodiment and the third embodiment is that the display device 500 further includes the preprocessing circuit 510. The preprocessing circuit 510 is electrically connected between the brightness information generating circuit 120 and the color space conversion circuit 420. The preprocessing circuit 510 is configured to receive the input image signal img_in and execute one or more preprocessing on the original pixels of the original frames. The preprocessing includes, for example, noise reduction, color space conversion, brightness adjustment, contrast adjustment, sharpness adjustment, color temperature adjustment, etc., and the disclosure is not limited thereto. In the embodiment, the color space conversion circuit 420 receives original frames that have been preprocessed and performs color space conversion on the original frames that have been preprocessed to generate original frames that have been converted.

In the fourth embodiment, the operating principles of the brightness information generating circuit 120, the conversion curve generating circuit 130, and the frame conversion circuit 140 are the same as those in the second embodiment, so they will not be reproduced here.

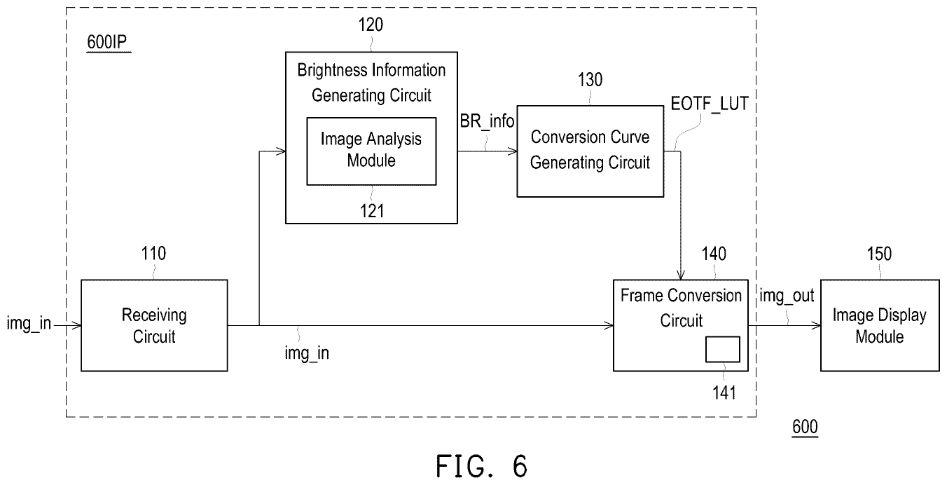

FIG. 6 is a system block diagram of a display device according to a fifth embodiment of the disclosure. A display device 600 includes, for example, at least one image processor 600IP. In the embodiment, the at least one image processor 600IP includes the receiving circuit 110, the brightness information generating circuit 120, the conversion curve generating circuit 130, and the frame conversion circuit 140. For specific implementations of the image processor 600IP, please refer to the description of the image processor 100P, which will not be reproduced here. In the display device 600 of the fifth embodiment, the frame conversion circuit 140 is directly connected to the receiving circuit 110 to receive the input image signal img_in from the receiving circuit 110. The brightness information generating circuit 120 is directly connected to a circuit to receive the input image signal img_in from the receiving circuit 110. The main difference between the fifth embodiment and the first to fourth embodiments is that the frame conversion circuit 140 is not electrically connected to the receiving circuit 110 through the brightness information generating circuit 120. In the embodiment, the operations executed by the brightness information generating circuit 120 and the conversion curve generating circuit 130 are the same as those in the first embodiment, so they will not be reproduced here.

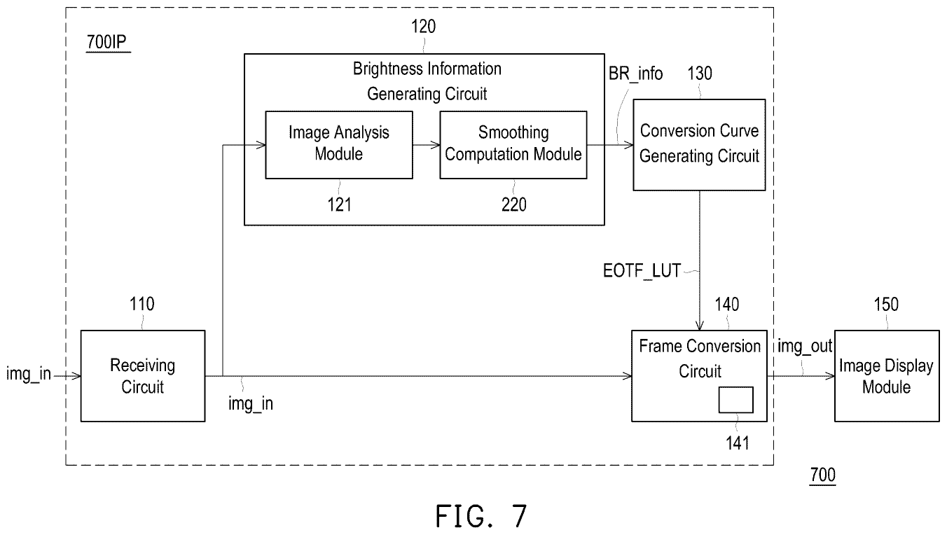

Moreover, the architecture of the fifth embodiment may also be combined with other embodiments. For example, in the embodiment shown in FIG. 7, a display device 700 may include at least one image processor 700IP. The at least one image processor 700IP includes the receiving circuit 110, the brightness information generating circuit 120, the conversion curve generating circuit 130, and the frame conversion circuit 140. The brightness information generating circuit 120 of the image processor 700IP further includes the smoothing computation module 220. For specific implementations of the image processor 700IP, please refer to the description of the image processor 100P, which will not be reproduced here. For example, the color space conversion circuit 420 in the third embodiment and the preprocessing circuit 510 in the fourth embodiment may be further included between the frame conversion circuit 140 and the receiving circuit 110.

In other words, in the fifth embodiment, the input image signal img_in is transmitted to the display device 600, and then divided into two paths. The path formed by transmitting from the receiving circuit 110 to the brightness information generating circuit 120 and the conversion curve generating circuit 130 is configured to analyze the brightness information in the input image information to generate the electro-optical transfer lookup table. The path formed by transmitting from the receiving circuit 110 to the frame conversion circuit 140 is configured to transmit the input image information to be processed.

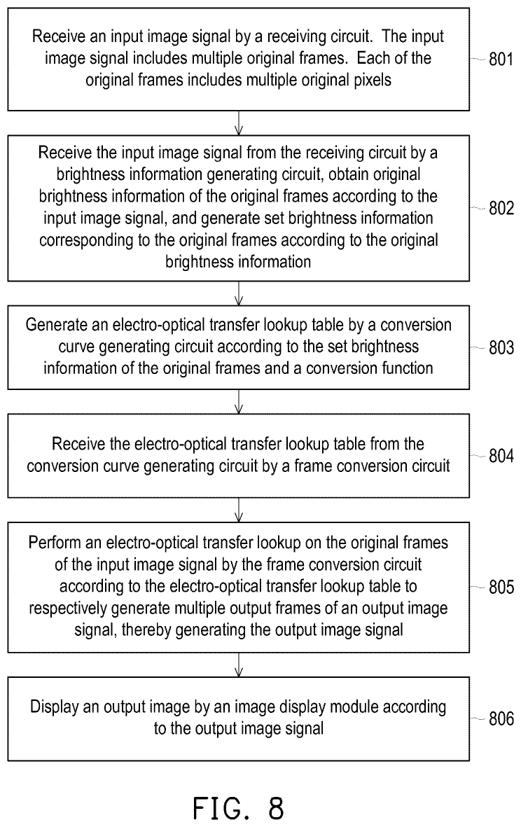

FIG. 8 is a flow chart of a display method according to the disclosure. Please refer to FIG. 8. In step 801, an input image signal is received by a receiving circuit. The input image signal includes multiple original frames. Each of the original frames includes multiple original pixels. In step 802, the input image signal from the receiving circuit is received by a brightness information generating circuit, original brightness information of the original frames is obtained according to the input image signal, and set brightness information corresponding to the original frames is generated according to the original brightness information. In step 803, an electro-optical transfer lookup table is generated by a conversion curve generating circuit according to the set brightness information of the original frames and a conversion function. In step 804, the electro-optical transfer lookup table is received from the conversion curve generating circuit by a frame conversion circuit. In step 805, electro-optical transfer lookup is performed on the original frames of the input image signal by the frame conversion circuit according to the electro-optical transfer lookup table to respectively generate multiple output frames of the output image signal, thereby generating the output image signal. Each of the output images includes multiple output pixels. In step 806, the output images are displayed by an image display module according to the output image signal. For detailed descriptions of each step in FIG. 8, please refer to the detailed descriptions of the display device 100 to the display device 700 in the disclosure, which will not be reproduced here.

In the disclosure, each step in FIG. 8 may be, for example, implemented through each of the circuits 110 to 150 in the foregoing first to fifth embodiments.

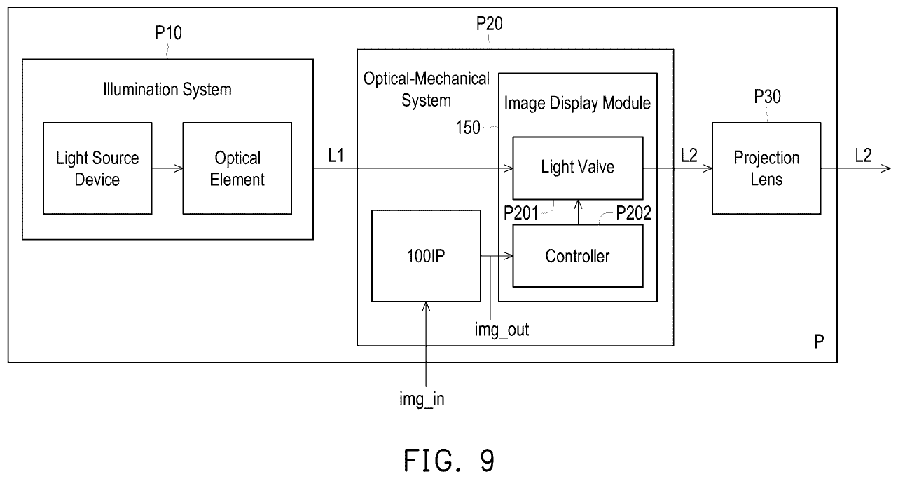

FIG. 9 is a block diagram of a projection device according to the disclosure. If the display device 100, 200, 400, 500, 600, or 700 is a projection device P, the projection device P includes an illumination system P10, an optical-mechanical system P20, and a projection lens P30. The illumination system P10 includes, for example, a light source device and at least one optical element (not labeled), configured to provide an illumination light beam L1 to the optical-mechanical system P20. The optical-mechanical system P20 includes, for example, the at least one of the image processors 100IP, 200IP, 400IP, 500IP, 600IP and 700IP, and the image display module 150 in the foregoing embodiments. The image display module 150 includes at least one light valve P201 and a controller (or a processor) P202 configured to control the at least one light valve P201. The controller (or the processor) P202 configured to control the at least one light valve P201 receives the output image signal img_out from the at least one of the image processors 100IP, 200IP, 400IP, 500IP, 600IP and 700IP. The at least one light valve P201 is disposed on a transmission path of an image light beam L2. The controller (or the processor) P202 controls the at least one light valve P201 to convert the illumination light beam L1 into the image light beam L2 according to the output image signal img_out. The projection lens P30 is disposed on a transmission path of the image light beam L2, and configured to project the image light beam L2 out of the projection device P.

In another embodiment, the at least one image processor may not be a part of the optical-mechanical system, that is, the projection device includes the illumination system, the at least one image processor from the foregoing embodiments, the optical-mechanical system, and the projection lens.

In the foregoing display device and display method, since the brightness information generating circuit 120 and the conversion curve generating circuit 130 are respectively independent circuit modules, the corresponding set brightness information and the electro-optical transfer lookup table may be generated for each of the original frames at a higher frequency. Even if the input image signal is not compatible with the HDR image format or belongs to a static HDR image format, the electro-optical transfer lookup table may be generated for each frame. Compared with the existing dynamic HDR technology, the electro-optical transfer lookup table can actually be generated for each frame, thereby truly optimizing each of the output frames. On the other hand, switching between scenes with different brightness can be smoother by the smoothing computation module 220, avoiding flickering or viewing discomfort.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A display device, comprising a receiving circuit, a brightness information generating circuit, a conversion curve generating circuit, a frame conversion circuit and an image display module, wherein:
the receiving circuit is configured to receive an input image signal, wherein the input image signal comprises a plurality of original frames, and each of the plurality of original frames comprises a plurality of original pixels;
the brightness information generating circuit electrically connected to the receiving circuit is configured to receive the input image signal from the receiving circuit, and the brightness information generating circuit obtains original brightness information of each of the plurality of original frames according to the input image signal, and generates set brightness information corresponding to each of the plurality of original frames according to the original brightness information;
the conversion curve generating circuit electrically connected to the brightness information generating circuit is configured to generate an electro-optical transfer lookup table according to the set brightness information of each of the plurality of original frames and a conversion function;
the frame conversion circuit electrically connected to the receiving circuit and the conversion curve generating circuit is configured to receive the electro-optical transfer lookup table corresponding to each of the plurality of original frames from the conversion curve generating circuit, and receive the input image signal from the receiving circuit and generate an output image signal; wherein the frame conversion circuit performs electro-optical transfer lookup on each of the plurality of original frames of the input image signal according to the electro-optical transfer lookup table corresponding to each of the plurality of original frames to generate a plurality of output frames of the output image signal, wherein each of the plurality of output frames comprises a plurality of output pixels; and
the image display module electrically connected to the frame conversion circuit is configured to receive the output image signal and display an output image according to the output image signal.

2. The display device according to claim 1, wherein the brightness information generating circuit comprises an image analysis module, the image analysis module receives the input image signal, and each original pixel of the plurality of original pixels of each of the plurality of original frames comprises a plurality of color channels; and the image analysis module is configured to calculate a maximum value among the plurality of color channels of the plurality of original pixels of each of the plurality of original frames to serve as the original brightness information.

3. The display device according to claim 2, wherein the brightness information generating circuit takes the original brightness information of each of the plurality of original frames to serve as the set brightness information corresponding to each of the plurality of original frames.

4. The display device according to claim 2, wherein the brightness information generating circuit further comprises a smoothing computation module, the smoothing computation module is electrically connected to the image analysis module to receive the original brightness information corresponding to each of the plurality of original frames, and the smoothing computation module is configured to determine whether the original brightness information of each of the plurality of original frames is lower than a brightness threshold;
if the original brightness information of the original frame being determined is lower than the brightness threshold, the smoothing computation module sets the brightness threshold as a target brightness value;
if the original brightness information of the original frame being determined is greater than or equal to the brightness threshold, the smoothing computation module sets the original brightness information as the target brightness value; and
the smoothing computation module generates the set brightness information of the original frame being determined according to a difference between the target brightness value and a previous set brightness information corresponding to a previous original frame of the original frame being determined.

5. The display device according to claim 4, wherein
if the difference between the target brightness value and the previous set brightness information exceeds a brightness adjustment value, and the target brightness value is greater than the previous set brightness information, the smoothing computation module adds a brightness adjustment value to the previous set brightness information to obtain the set brightness information of the original frame being determined among the plurality of original frames;
if the difference between the target brightness value and the previous set brightness information exceeds the brightness adjustment value, and the target brightness value is less than the previous set brightness information, the smoothing computation module subtracts the brightness adjustment value from the previous set brightness information to obtain the set brightness information of the original frame being determined; and
if the difference between the target brightness value and the previous set brightness information is less than or equal to the brightness adjustment value, the smoothing computation module sets the target brightness value as the set brightness information of the original frame being determined.

6. The display device according to claim 1, wherein the display device further comprises a signal processing circuit and a color space conversion circuit, wherein
the receiving circuit is further configured to obtain metadata of the input image signal from the input image signal;
the signal processing circuit is electrically connected to the receiving circuit, receives the metadata from the receiving circuit, and determines whether the input image signal is compatible with a high dynamic range format according to the metadata; and
the color space conversion circuit is electrically connected to the signal processing circuit to receive the metadata, and stores display color space information corresponding to the display device; wherein,
if the signal processing circuit determines that the input image signal is compatible with the high dynamic range format, the color space conversion circuit is configured to convert the plurality of original pixels of each of the plurality of original frames from an original color space to a display color space according to original color space information and the display color space information comprised in the metadata; wherein,
the frame conversion circuit is electrically connected to the color space conversion circuit to receive a plurality of original frames that have been converted, and performs electro-optical transfer lookup on each of the plurality of original frames that have been converted to generate the plurality of output frames.

7. The display device according to claim 1, wherein the frame conversion circuit performs electro-optical transfer lookup on the plurality of original pixels of each of the plurality of original frames of the input image signal according to the electro-optical transfer lookup table corresponding to each of the plurality of original frames to generate the plurality of output pixels of each of the plurality of output frames of the output image signal.

8. The display device according to claim 1, wherein the brightness information generating circuit is electrically connected between the frame conversion circuit and the receiving circuit, so that the receiving circuit is electrically connected to the frame conversion circuit through the brightness information generating circuit, and the frame conversion circuit receives the input image signal from the receiving circuit through the brightness information generating circuit.

9. The display device according to claim 1, wherein the frame conversion circuit is directly connected to the receiving circuit to receive the input image signal from the receiving circuit.

10. A display method, executed by a display device, wherein the display device comprises a receiving circuit, a brightness information generating circuit, a conversion curve generating circuit, a frame conversion circuit and an image display module, and the display method comprises the following steps:
receiving an input image signal by the receiving circuit, wherein the input image signal comprises a plurality of original frames, and each of the plurality of original frames comprises a plurality of original pixels;
receiving the input image signal from the receiving circuit by the brightness information generating circuit, obtaining original brightness information of each of the plurality of original frames according to the input image signal, and generating set brightness information corresponding to each of the plurality of original frames according to the original brightness information;
generating an electro-optical transfer lookup table by the conversion curve generating circuit according to the set brightness information of each of the plurality of original frames and a conversion function;
receiving the electro-optical transfer lookup table corresponding to each of the plurality of original frames from the conversion curve generating circuit by the frame conversion circuit, receiving the input image signal from the receiving circuit, and generating an output image signal; and
displaying an output image by the image display module according to the output image signal; wherein
a step of generating the output image signal is performing electro-optical transfer lookup on each of the plurality of original frames of the input image signal by the frame conversion circuit according to the electro-optical transfer lookup table corresponding to each of the plurality of original frames to respectively generate a plurality of output frames of the output image signal, wherein each of the plurality of output frames comprises a plurality of output pixels.

11. The display method according to claim 10, wherein the brightness information generating circuit comprises an image analysis circuit, and each original pixel of the plurality of original pixels of the original frames comprises a plurality of color channels; and the display method further comprises the following step:
calculating a maximum value among the plurality of color channels of the plurality of original pixels of each of the plurality of original frames by the image analysis circuit to serve as the original brightness information.

12. The display method according to claim 11, wherein in steps of generating the set brightness information according to the original brightness information, the original brightness information of each of the plurality of original frames is taken to serve as the set brightness information of each of the plurality of original frames.

13. The display method according to claim 11, wherein the brightness information generating circuit further comprises a smoothing computation module, and steps of generating the set brightness information according to the original brightness information comprise:
determining by the smoothing computation module whether the original brightness information corresponding to each of the plurality of original frames is lower than a brightness threshold;
setting the brightness threshold as a target brightness value by the smoothing computation module if the original brightness information of the original frame being determined is lower than the brightness threshold;
setting the original brightness information as the target brightness value by the smoothing computation module if the original brightness information of the original frame being determined is greater than or equal to the brightness threshold; and
generating the set brightness information of the original frame being determined by the smoothing computation module according to a difference between the target brightness value and a previous set brightness information corresponding to a previous original frame of the original frame being determined.

14. The display method according to claim 13, wherein steps of generating the set brightness information of the original frame being determined by the smoothing computation module according to the difference between the target brightness value and the previous set brightness information corresponding to the previous original frame of the original frame being determined comprise:
adding a brightness adjustment value to the previous set brightness value by the smoothing computation module to obtain the set brightness information of the original frame being determined if the difference between the target brightness value and the previous set brightness information exceeds the brightness adjustment value, and the target brightness value is greater than the previous set brightness information;
subtracting the brightness adjustment value from the previous set brightness information by the smoothing computation module to obtain the set brightness information of the original frame being determined if the difference between the target brightness value and the previous set brightness information exceeds the brightness adjustment value, and the target brightness value is less than the previous set brightness information; and
setting the target brightness value as the set brightness information of the original frame being determined by the smoothing computation module if the difference between the target brightness value and the previous set brightness information is less than or equal to the brightness adjustment value.

15. The display method according to claim 10, wherein the display device further comprises a signal processing circuit and a color space conversion circuit, and the display method comprises:
obtaining metadata of the input image signal from the input image signal by the receiving circuit;
determining by the signal processing circuit whether the input image signal is compatible with a high dynamic range format according to the metadata;
receiving the metadata by the color space conversion circuit, and storing display color space information corresponding to the display device; and
converting the plurality of original pixels of each of the plurality of original frames from an original color space to a display color space by the color space conversion circuit according to an original color space information and the display color space information comprised in the metadata if the signal processing circuit determines that the input image signal is compatible with the high dynamic range format; wherein,
the frame conversion circuit performs electro-optical transfer lookup on a plurality of original frames that have been converted to respectively generate the plurality of output frames.

16. The display method according to claim 10, wherein steps of performing electro-optical transfer lookup on the plurality of original frames of the input image signal by the frame conversion circuit according to the electro-optical transfer lookup table corresponding to each of the plurality of original frames to generate the plurality of output frames of the output image signal comprise:
performing electro-optical transfer lookup on the plurality of original pixels of each of the plurality of original frames of the input image signal by the frame conversion circuit to generate the plurality of output pixels of each of the multiple output frames of the output image signal.
